(19) United States
(12) Patent Application Publication
(10) Pub. No.: US 2011/0174231 A1
(43) Pub. Date: Jul. 21, 2011

(54) Systems and Methods for Remote Placement of Electrified Fish Barriers

(76) Inventors: Joseph Curtis Edmondson, Beaverton, OR (US); Lee Roy Carstensen, Vancouver, WA (US); Michael Holliman, Vancouver, WA (US)

(21) Appl. No.: 13/009,461

(22) Filed: Jan. 19, 2011

Related U.S. Application Data
(60) Provisional application No. 61/296,406, filed on Jan. 19, 2010.

(51) Int. Cl. A01K 63/02

(52) U.S. Cl. 119/220

(57) ABSTRACT

The inventive subject matter describes systems and methods for the remote placement of electrified fish barriers are illustrated and described herein. The inventive subject matter describes a floating electrical barrier that is responsive to the presence of detected fish. The inventive subject matter also describes a multiplicity of electrical barriers that are arranged to create an electrical field that entrains certain species of fish. The inventive subject matter also describes a movable barrier that is used to guide fish from location to location using electrical fields.

### BACKGROUND

The present inventive subject matter relates to the systems and methods for the remote placement of movable electrified fish barriers.

The protection and preservation of natural resources includes the management of fish and game. Fish move about lakes, rivers, streams and reservoirs for a variety of reasons, including migration, spawning, and searching for food.

Water intakes divert water for drinking, irrigation, and industrial uses. The introduction of fish into intakes is generally regarded as unwanted, and, in some cases, is expressly prohibited by federal government mandates such as the “Endangered Species Act” and the EPA “Clean Water Act.” Many rivers have hydroelectric, fossil fuel and nuclear power plants with water intakes to the hydroelectric turbines and for cooling. It is desirable to keep the fish out of these intakes and away from dangerous conditions. Many large bodies of water are linked by inland waterways, including natural rivers and man made canals. Some of these bodies of water have diverse fish and wild life that are foreign to each other. Because migration across such natural divides can upset the ecological balance, government mandates often require that construction and use of such waterways incorporate a method or apparatus for controlling ecologically harmful migration through these waterways. As a consequence, all water diversions require governmental licenses and/or permits, and require periodic re-licensing. The water diversions must be upgraded to satisfy any changes in government regulations at the time of re-licensing. For these, and a variety of other economic, commercial, cultural and ecological reasons, it is often necessary to govern the migration and random motion of fish.

As the need for governing the movement and migration of fish has been recognized, means for achieving this goal have also been developed. Electric fish barriers, such as described in U.S. Pat. No. 4,750,451 to Smith, have become a common and useful means for governing the migration and travels of fish in lakes, locks, rivers, dams, fisheries and other restricted or controlled areas.

Furthermore, electrofishing barriers and techniques of electrofishing have also been used freshwater lakes and streams and are the subject of U.S. Pat. Nos. 5,445,111; 5,327,854; 4,672,967; 4,713,315; 5,111,379; 5,233,782; 5,270,912; 5,305,711; 5,311,694; 5,327,668; 5,341,764; 5,551,377; and 6,978,734 which are incorporated herein by reference. Also, electrofishing has been the used to stimulate yields of fishing in conjunction with the use of trawl nets as described in U.S. Pat. Nos. 3,110,978 and 4,417,301 which are also incorporated herein by reference. Systems for controlling electricity in aquatic environments have been described in U.S. Pat. No. 5,460,123 which is incorporated herein by reference.

In electric fish barriers, an electrical irritation or shock is only felt by a fish when there is a voltage differential across the fish thereby driving an electrical current through a fish. Accordingly, the most significant factor in controlling the motion of fish is not the field strength, with respect to ground, where the fish is located, but the voltage gradient where the fish is located. Field voltage gradient is the rate of change in voltage of an electric field per linear measure. Although the instantaneous axis of the linear measurement can be in any direction, the maximum field gradient is measured across a unit length of a one dimensional line oriented perpendicular to the two dimensional surface representing an equipotential voltage plane. The instantaneous voltage differential across unit distance is thus the electric field gradient, or voltage gradient. The higher the voltage gradient, the greater the total voltage drop across a fish, and consequently, the greater the electrical current that will pass through a fish.

Because a gradient times a linear distance equals a voltage potential, it can be understood that the longer a fish, the greater the total voltage drop across the fish. Similarly, because resistance is inversely proportional to the cross sectional area of a resistor, and because a large fish typically has a proportionally larger cross sectional area, the larger the fish, the lower the resistance of the fish. The size of a fish, therefore, affects the electrical current flow through the fish for several reasons as illustrated above.

The maximum transfer of energy from water to a fish occurs when the fish's electrical conductivity matches the electrical conductivity of the surrounding water. In most circumstances, a fish's body is normally more conductive than fresh water. As a result, the fish's body acts as a “voltage divider” when swimming through fresh water, and the gradient of an electrical field in the body of a fish will typically be less than the voltage gradient in the same space filled by fresh water. That is, the voltage gradient is altered in a region proximate a fish in the zone of an electric fish barrier. Nevertheless, all other factors remaining equal, the voltage gradient in the body of a fish will be roughly proportional to the voltage gradient in the same region of fresh water when no fish are present. Accordingly, if the voltage gradient in a region of water is doubled, the voltage gradient across the fish (and the electrical current through the fish) will also double. The effectiveness of an electric fish barrier on a particular fish, therefore, depends on the voltage field gradient produced by the electric fish barrier.

The voltage gradients in the region of water may be adjusted to cause a physiological reaction in the fish. If a voltage gradient in a region of water is too weak, the fish will not feel appreciable discomfort, and will travel undaunted by the electric fish barrier. An “annoying region” will cause a fish to turn around and travel the preferred route. Conversely, early experiments have demonstrated that if a moderately annoying region of the electric barrier is too narrow to allow a fish to turn around, then the rapidly swimming fish passes quickly through the “annoying” region and then into the “painful region”. The rapid transition from the annoying to the painful may induce large fish to react so violently in their attempt to change direction that they have actually snapped their own spine. As a result of these observations, an ideal fish barrier will normally have a wide region with a moderately annoying voltage gradient, increasing at a rate that causes increasing discomfort to fish of various sizes and species, but allowing ample room for a fish experiencing discomfort to turn around before passing completely through the annoying region and into a painful or lethal region. The awareness of the field gradient should, therefore, not be a sudden discovery, but a gradually growing annoyance. Whether a fish barrier is effective, ineffective or harmful is thus a function of the shape of the boundary, the thickness and the intensity of a voltage gradient produced by an electric fish barrier.

The current passing through a fish depends on a variety of factors such as the conductivity of the water at both ends of the fish, the total resistance in a conductive path of water, and the size and species of a fish being repelled, etc. Typically, higher gradients are necessary to control the travel and migration of smaller fish, and lower gradients are effective for larger fish. The effectiveness of a particular strength gradient also depends on the species of fish, and whether the motion of the water reliably flows in a direction to orient the fish along the axis of the strongest gradient, which is perpendicular to the equipotential voltage plane. However, a voltage gradient of one hundred volts per meter has been observed to establish a good base-line voltage gradient for effectively and yet safely deterring average size fish from entering a prohibited area. It is understood that higher and lower voltage gradients may be appropriate according to a variety of factors. First, the electric field is generated fixed barrier that typically runs along the bottom of a riverbed.

FIG. 1 illustrates a multi-stage fish barrier known in the prior art for regulating the traffic of fish in shallow waterways. According to this example, fish 9 within a waterway 10 seek to migrate up river (against the water flow), and the electric barrier is configured to direct them to an alternative route 11. Five electrodes 13-17 rest on a substrate 12 within riverbed 10. The five electrodes 13-17 separate the stream or river into four separate voltage gradient regions 18-21. The electrodes 13-17 are advantageously formed from elongated members, such as cables or extruded bars. Although copper conducts electricity well, galvanic effects between copper and water can prematurely erode copper cables, requiring frequent replacement. Additionally, in water having a sulfur content, the ionized copper can form copper sulfate compounds in water, which can be poisonous to fish. For these reasons, a ferrous metal is usually preferred for forming the elongated members of the electrodes 13-17, such as steel cables, beams, or railroad track segments. The elongated members 13-17 are oriented perpendicular to the direction of water flow, which, in most confined river areas, also creates a geometrically parallel orientation among the elongated members.

The electrodes 13-17 of FIG. 1 are arranged at one meter intervals, and the voltage levels are controlled such that the relative voltage between two electrodes is continually increasing. Electrode 13 is at a zero or ground potential, and electrode 14 is at a one hundred volt peak potential, so that the peak differential between electrodes 13 and 14 is a one hundred volt differential. Electrode 15 is at a three hundred volts peak potential, so that the peak differential between electrodes 14 and 15 is a two hundred volt differential. Electrode 16 is at a six hundred volts peak potential, so that the peak differential between electrodes 15 and 16 is a three hundred volt differential. Electrode 17 is at a one thousand volts peak potential, so that the peak differential between electrodes 16 and 17 is a four hundred volt differential.

Since the distance between the electrodes 13-17 remains a constant one-meter, the voltage gradient in each region 18-21 is greater than the previous region. In region 18, the gradient is one hundred volts per meter. In region 19, the gradient is two hundred volts per meter. In region 20, the gradient is three hundred volts per meter. In region 21, the gradient is four hundred volts per meter. As a fish advances into a progressively higher voltage gradient, the electrical current passing through that fish increases proportionally. Through the multi-stage barrier of FIG. 1, fish of a size or species that are not annoyed by a lower voltage gradient will be progressively exposed to higher voltage gradients, eventually forcing all migrating fish to turn around and select the alternative path 11 in their upstream travels. Although the multi-step barrier of FIG. 1 can be effective in a shallow stream, the incremental regulation of voltage gradients is not reliably formed by single-step or multi-step designs of the prior art in deeper water applications.

FIG. 2 is a prior art cross sectional view of a stream or river nine meters deep, illustrating the equi-gradient field lines of an electric field produced by two elongated members 30, 31 on a riverbed. The direction of river flow is along the w-axis. The elongated members 30, 31 are separated by fourteen meters in the direction of river flow, and disposed at the bottom of a river 32, perpendicular to the direction of flow. The conductivity of the river water is 500.mu. Siemens. A one kilovolt differential is generated between the two elongated members 30, 31.

As discussed above, the basic operational parameter of an electric fish barrier is the voltage gradient of an electric field, and a gradient of 100 volts per meter is a common benchmark for an operational system. If the field gradient between the two conductors 30, 31 were completely linear, one thousand volts over a fourteen meter range would produce a continuous gradient of seventy-one volts per meter. As the field gradient patterns of FIG. 2 indicate, however, the field gradient is not uniform between the two conductors 30, 31. A field gradient of sufficient strength must extend all the way to the surface to prevent passage of fish past the barrier. Because fish can travel on the surface where the gradient is weakest, the strongest gradient value to extend all the way to the surface is an important value for profiling the efficacy of a fish barrier. The strongest voltage gradient extending to the river surface in FIG. 2 was measured at 25 volts per meter. On the bottom of the riverbed, near the conductive elongated members 30, 31 viewed end-wise, the higher field gradients more closely resemble concentric cylinders formed around the respective elongated conductive members 30, 31. As one approaches the conductive members 30, 31, the path leading to a conductive member 30, 31 is distinguished by a voltage potential that changes rapidly over distance, which equates to a high voltage gradient.

Because effective blocking of fish from migrating up or downstream would require a minimum gradient of 100 volts per meter everywhere in a cross-sectional plane to the direction of flow of the river, calculations were performed normalizing the surface gradient at one hundred volts per meter according to the prior art design of FIG. 2. At this normalized value, the calculations disclose that a peak voltage difference of 4.032 kilovolts between the elongated members 30, 31 would be required to produce a surface gradient of one hundred volts per meter. At the level of 4.032 kilovolts potential between the elongated members 30, 31, the electrical current produced by the normalized electric field pattern in a river nine meters deep and one meter wide would be 52.5 amps at a conductivity of 500 micro Siemens. Although certain fish species have shown a deterrent effect at a voltage threshold of 100 Volts per meter (1 V/cm), it has been observed that certain mammalian species may be deterred at a voltage threshold much less than 1 V/cm. For example California sea lions tested at Moss Landing Marine Labs are able to detect underwater DC electric fields of 0.14 v/cm at pulse frequencies of 2 Hz and pulse width from 80 to 290 μs (0.00008 to 0.00029 secs). The sea lions are apparently deterred when the field pulse widths are increased to an amount of approximately 320 μS.

Likewise, Manatees, (e.g. marine mammals of the order Sirenia, also known as “sea-cows”) are believed to be affected by electric fields. These animals can be found in shallow waters, bays, canals and coastal areas. The manatee has a streamlined body, with two flippers and one paddle-shaped tail. Their true color is gray, although it may appear brownish gray. Adult manatees can grow up to 12 feet in length and weigh around 1,800 pounds.

As shown in the prior art, a fixed electrical barrier is taught for the deterrence of certain fish and mammalian species. Whereas a fixed electrical barrier has certain advantages for the guidance and deterrence of certain fish and mammalian species, it cannot be positioned in a body of water to change the relative position of the field.

Furthermore, is may be necessary to temporarily entrain fish or marine mammals in a specified locations due to changing conditions in that body of water.

For marine mammals such as seals, certain voltage gradients in the water produce a deterrent effect where the marine mammal seeks to avoid the electric field. These levels are approximately 0.32 V/cm gradient, a pulse width of 1 millisecond, and a frequency of 2 hz (a duty cycle of 0.5%). At this voltage gradient and duty cycle, the marine mammal is deterred, but the local fish are apparently unharmed. The benefit is that lower voltage gradients are effective at deterring pinnipeds and do not affecting fish. Lower voltage gradients generally result in lower power dissipation in the water. In view of the lower power dissipation, the use of mobile barriers can be considered both practical and feasible in the deterrence of marine mammals. Therefore, what is desired is a floating apparatus that provides a electric field gradient to entrain marine mammals. The floating apparatus may be configured individually or in multiple units to provide field configuration.

Furthermore, the units may be configured remotely and/or in response to schools of fish to automatically entrain fish in specific locations.

### SUMMARY

The present inventive subject matter overcomes problems in the prior art by providing for systems and methods for the remote placement of electrified fish barriers are illustrated and described herein. The inventive subject matter describes a floating electrical barrier that is responsive to the presence of detected fish. The inventive subject matter also describes a multiplicity of electrical barriers that are arranged to create an electrical field that entrains certain species of fish. The inventive subject matter also describes a movable barrier that is used to guide fish from location to location using electrical fields.

These and other embodiments are described in more detail in the following detailed descriptions and the figures.

The foregoing is not intended to be an exhaustive list of embodiments and features of the present inventive subject matter. Persons skilled in the art are capable of appreciating other embodiments and features from the following detailed description in conjunction with the drawings.

### BRIEF DESCRIPTION OF THE DRAWINGS

FIG. 1 is a prior art diagram of a graduated electrical field barrier.

FIG. 2 is a prior art diagram depicting the electrical field intensity between fixed anodes and cathodes.

FIG. 3 is a side view of an embodiment of the inventive subject matter with a single craft having an anode a cathode, and a pulsator.

FIGS. 4a and 4b are top views of an embodiment of the inventive subject matter having two crafts each having a pulsator with an interconnecting electrical cable.

FIG. 5 is a top view of an embodiment of the inventive subject matter depicting two crafts being positioned relative to a school of fish.

FIG. 6 is a top view of an embodiment of the inventive subject matter depicting two crafts entraining fish such that the fish are guided from a spillway to a raceway.

### DETAILED DESCRIPTION

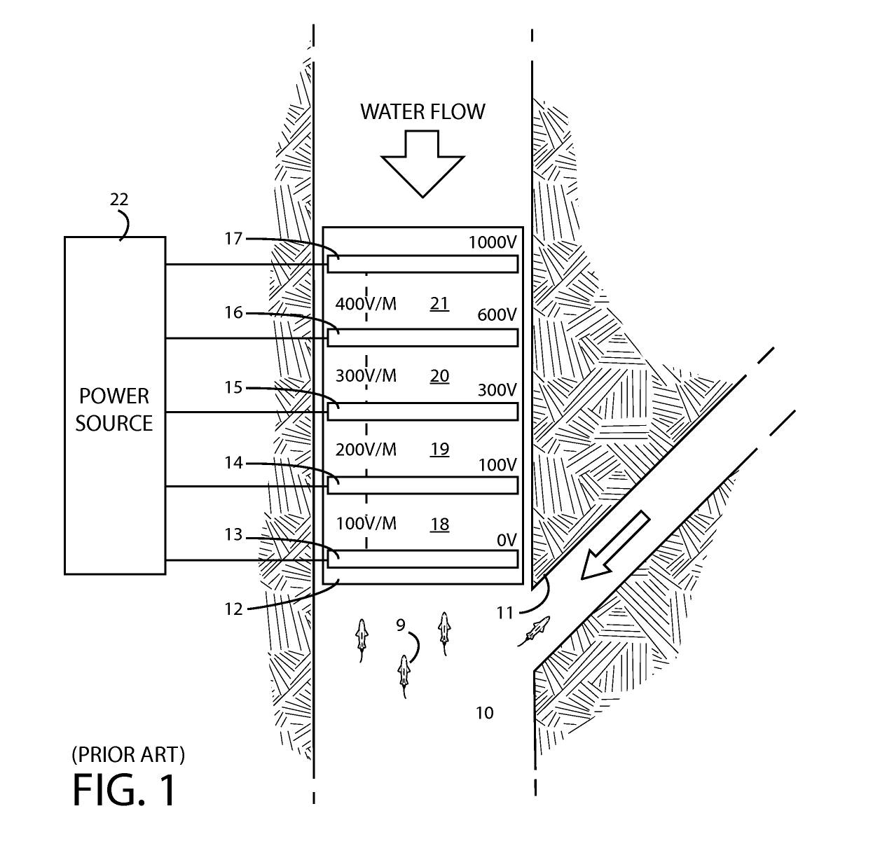

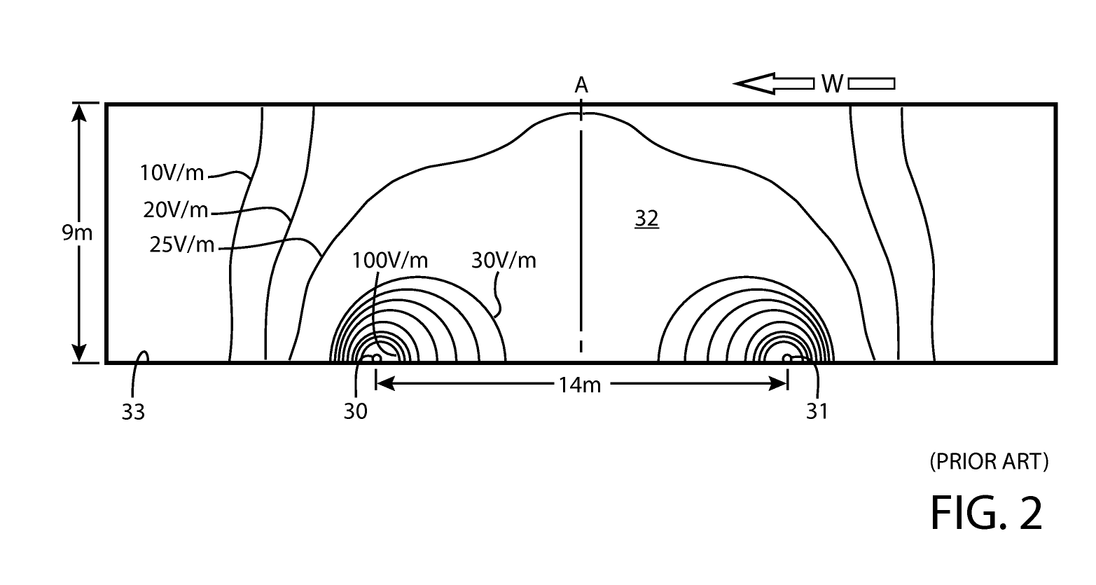

Representative embodiments according to the inventive subject matter are shown in FIGS. 1-6, wherein similar features share common reference numerals.

The term “aquatic animal” generally refers to an animal that lives in a conductive medium, including, but not limited to fish, mammals, and other species.

The term “boat” is generally known to those in the arts as a large floating object capable of containing electronics needed to produce an electrical field as described in this application. The electrical field being dependent on the

The term “electrical stimulation” refers to an electrical field impressed on the tissue of a fish in water. This electrical field will have a range in values that is dependent on the size and orientation of the fish.

The term “entrainment response” refers to a physiological reaction by an aquatic animal to the imposition of an electric field on the body of the aquatic animal. The term “pulsator” shall mean a device that can output a range of voltages and currents in a waveform that is programmed either by hardwire switch (e.g., a pulse generator) or by software (e.g. a computer controlled voltage generator). A pulsator creates a voltage differential between the anode lead (e.g. first electrode) and the cathode lead (e.g. second electrode) when the first and second electrodes are inserted into a conductive medium (i.e. water).

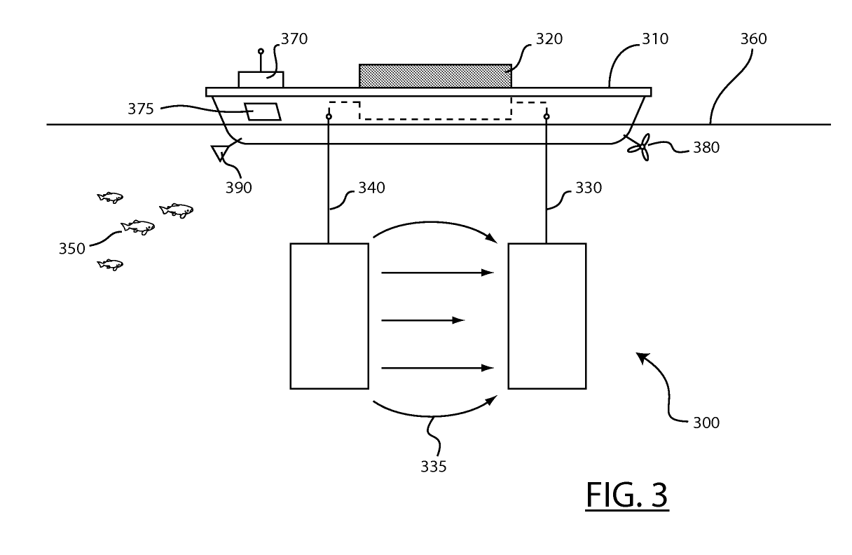

Now referring to FIG. 3 which illustrates the side cross-sectional view of the floating electrified fish barrier 300. The watercraft 310 contains a pulsator 320, which is connected to a first electrode 330 and a second electrode 340. The first electrode 330 and the second electrode 340 are placed proximate to aquatic animals, mammals and/or schools of fish 350.

The watercraft 310 floats on the surface of the water 360 which is inherently conductive. The pulsator 320 is connected to a remote control device 370 that can be used to control the pulsator 320 and/or the propulsion and steering mechanism 380 that is integral to the watercraft 310.

The watercraft 390 also has a fish finder 390. The fish finder 390 can detect and/or characterize fish using acoustical (e.g. sound), optical, or electrical sensing techniques. The term “fish finder” should not be limited to a system that can locate only fish, rather, this term should be construed broadly to include not only fish, but, aquatic mammalian species, crustaceans, and swimming humans.

Operationally, the watercraft 310 induces an electrical field 335 between the first electrode 330 and the second electrode 340. The electrical field 335 is of a sufficient field strength to induce the desired effect on the subject species of fish. For example, certain salmonid species may exhibit the desired response to the electrical field 335 when the voltage gradient is 0.1 to 4.0 volts per in (0.1-4.0 v/in). This electrical field 335 can be generated by commercially available electrical generators, such as, the Smith-Root™ brand of electric field pulsators. By manipulation of the electric field, (e.g. the strength, the direction, and intensity), an entrainment response can be invoked in the target aquatic species.

Additionally, the watercraft can be position proximate to groupings of fish (e.g. schools) such that the maximal effect of the electrical field can be induced on these schools of fish 350. The positioning may be done manually via a remote control 370 or locally via a control unit 375 connected to the fish finder 390.

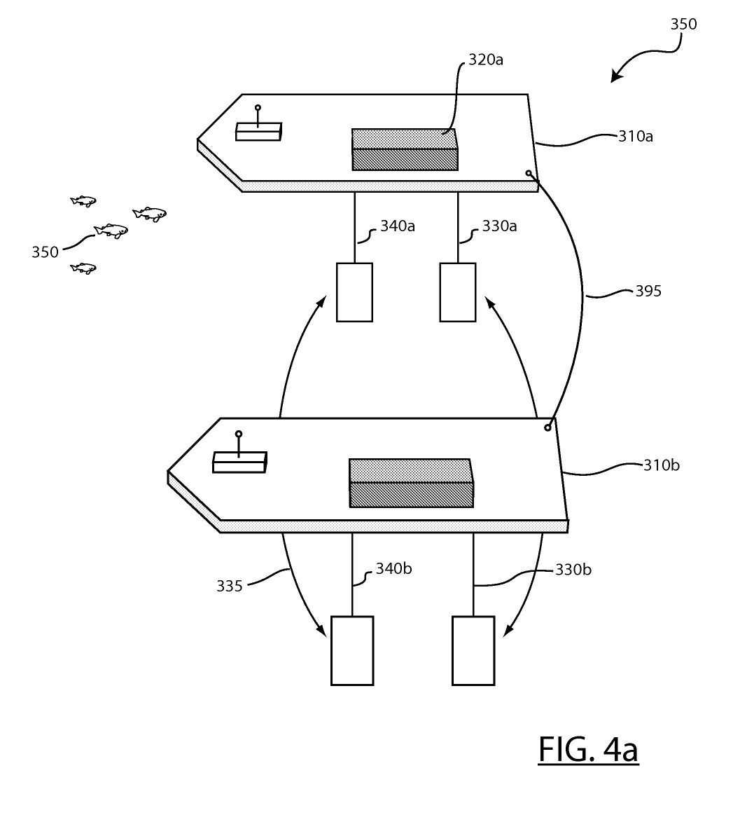

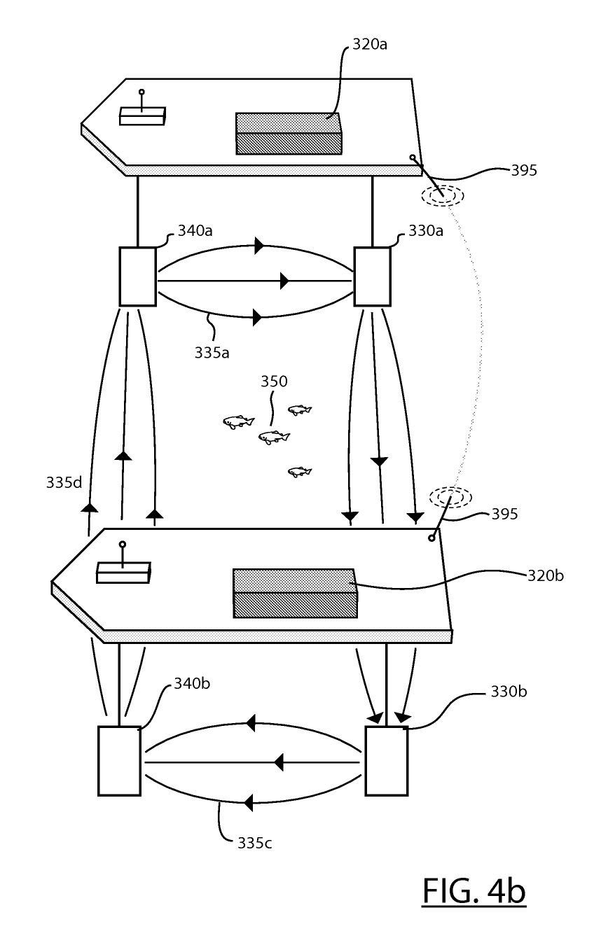

Now referring to FIG. 4a which illustrates a pair of watercraft 305 interconnected by a connection cable 395. In this configuration the electrical field 335 is generated between the first watercraft 310a and the second watercraft 310b. For example electrodes 340a, 330a can be configured as the anode and electrodes 340b, 330b c can be configured as cathodes. In this configuration, the field is present between the first watercraft and the second watercraft.

As shown in FIG. 4b, is an alternate configuration involving the two watercraft 310a,310b. The watercraft 310a, 310b may be configured such that the electrodes 330a, 330b, 340a, 340b define a perimeter around the watercraft 310a, 310b. By energizing the electrodes in a rotating pattern (e.g., 340a(+)/330a(−), 330a(+)/330b(−), 330b(+)/340b(−), 340b(+)/340a(−), 340a(+)/330a(−), etc.), the resultant field encircles objects within the perimeter. This electrical field creates, in essence, a “electrical fence” that can be used to entrain fish within the fixed perimeter.

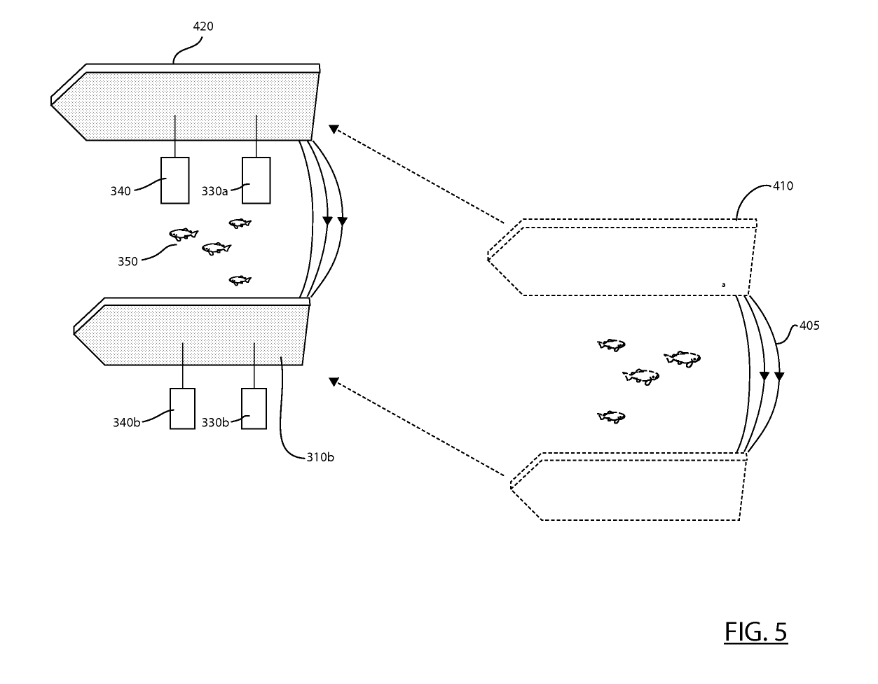

FIG. 5 depicts the entrainment and movement of fish using electrical fields. The watercraft 310a, 310b start at a first location 410 with the electrical field energized to contain the fish 350 within the perimeter. As the watercraft 310a, 310b moves to the second location 420, the fish 350 are guided by the sensing of the increasing electrical fields. For example, as the watercraft 310a, 310b move forward, fish 350 that are closest to the rear electrical field 405 will cause the fish 350 to be moved forward due the fish's 350 natural aversion to an electrical field.

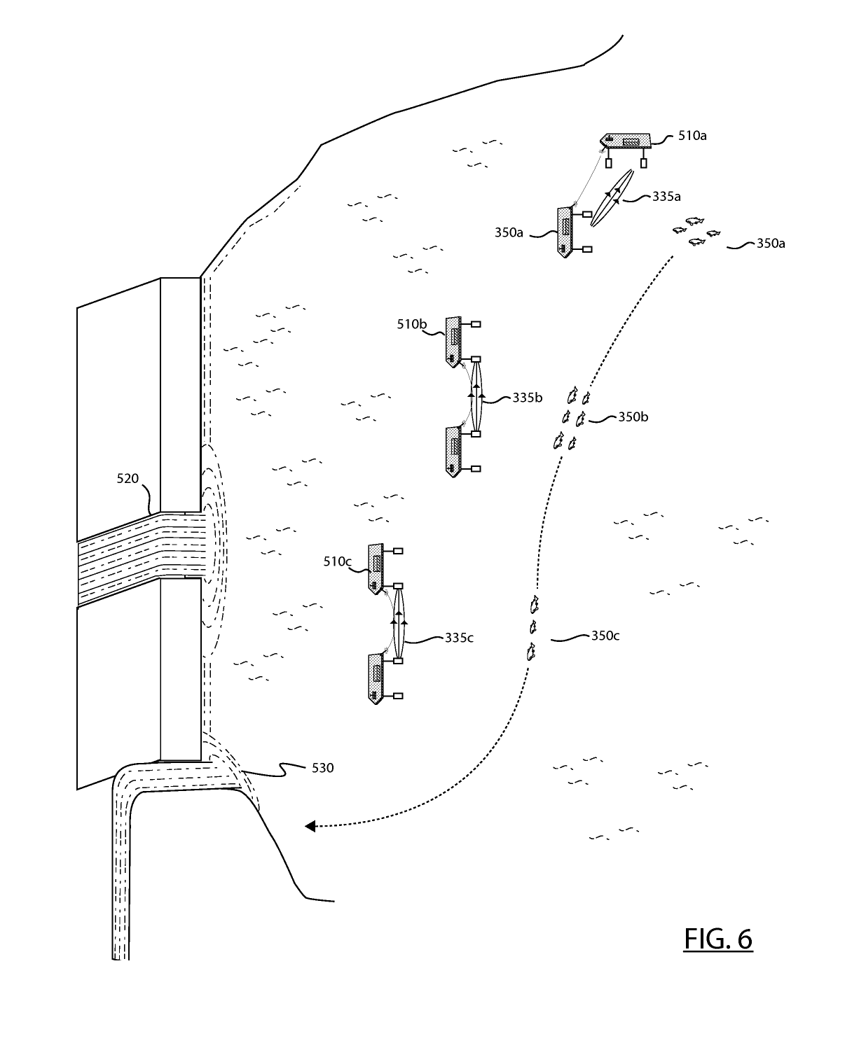

Now referring FIG. 6, the fish 350a, 350b, 350c are entrained and guided by the use of a moving electrical field. The fish 350a, 350b, 350c swim towards the water spillway 520. At a point 510a, the fish 350a encounter the electrical field 335a created by the watercraft 310a, 310b, and due to the electrical field the fish are repulsed away from the watercraft 310a, 310b, and at the same time are forced towards the spillway 520 due to the natural force of the water. As the watercraft 310a, 310b, 310c moves, the fish are guide to an alternative water discharge point, for example a fish raceway 530.

As previously indicated, the watercraft 310a, 310b may be guided by the use of onboard and/or remote fish detection devices, such as sonar, optical cameras, electrical fish detectors, and/or other detection mechanisms.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

All patent and non-patent literature cited herein is hereby incorporated by references in its entirety for all purposes.

1. A floating electrified fish barrier comprising:
a multiplicity of electrically interconnected mobile watercraft, each watercraft further comprising a pulsator, wherein each pulsator has a first electrode and a second electrode opposite polarities;
wherein said first electrode and said second electrode of each watercraft are capable of creating an electric field in a conductive medium;
so that the mobile electric field induces an entrainment response in fish that are disposed proximately to the mobile electric field.

2. The floating electrified fish barrier as described in claim 1 wherein the number of electrically interconnected mobile water craft are two.

3. The floating electrified fish barrier as described in claim 1 wherein the interconnected mobile watercraft changes position during operation.

4. The floating electrified fish barrier as described in claim 1 wherein the potential difference between the first electrode and the second electrode is less than one volt per centimeter.

5. The floating electrified fish barrier as described in claim 1 wherein the potential difference between the first electrode and the second electrode operates at a frequency of less than two hertz.

6. The floating electrified fish barrier as described in claim 1 wherein the potential difference between the first electrode and the second electrode operates at a pulse width of less than one millisecond.

7. The floating electrified fish barrier as described in claim 1 wherein the fish barrier further comprises a fish finder.

8. The floating electrified fish barrier as described in claim 1 where said fish finder senses fish using techniques selected from a group of acoustical waveforms, optical waveforms, or electrical sensing techniques.

9. A method of deterring aquatic species comprising the steps of:
selecting a multiplicity of pulsators, each pulsator having a pair of electrodes, wherein each pair of electrodes further comprise an anode and a cathode;
arranging the multiplicity of pulsators such that the anode and cathode of each electrode entrain an aquatic animal;

10. The method of deterring aquatic species as described in claim 9 further comprising the steps of:
setting the potential difference between the first electrode and the second electrode to operate at a frequency of less than two hertz.

11. The method of deterring aquatic species as described in claim 9 further comprising the steps of:
setting the potential difference between the first electrode and the second electrode to less than one volt per centimeter.

12. The method of deterring aquatic species as described in claim 9 further comprising the steps of:
detecting aquatic organisms proximate to the electrodes using a fish finder.
